(19) United States
(12) Patent Application Publication
(10) Pub. No.: US 2006/0284064 A1
(43) Pub. Date: Dec. 21, 2006

(54) Door assembly for a semi-automatic micro-hole plate single-photon counter

(76) Inventors: Encong Liu, Beijing (CN); Jinsheng Yu, Beijing (CN); Xiaolin Yang, Beijing (CN); Zhian Wang, Beijing (CN); Xiaodong Wu, Beijing (CN)

Correspondence Address: BERENATO, WHITE & STAVISH, Suite 240, 6550 Rock Spring Drive, Bethesda, MD, 20817, US

(21) Appl. No.: 11/337,808

(22) Filed: Jan. 24, 2006

(30) Foreign Application Priority Data
Jun. 20, 2005 (CN) 200510078399.6

(51) Int. Cl. H01J 40/14; H01J 5/02

(52) U.S. Cl. 250/239

(57) ABSTRACT

The present invention relates to a door assembly provided on the housing of a semi-automatic micro-hole plate single-photon counter, said door assembly being mounted on a door opening being cooperated with the door opening to open it or close it so as, said door assembly comprising a door shaft, a door body and a door frame, wherein the door opening is provided on a side wall of the housing, the door frame is fixedly mounted on the door opening, the door body is mounted on the door frame by the door shaft, labyrinth sealing structures which can cooperate with each other are provided on the door body and the door frame, the door body is pivotable around the door shaft so as to open or close the door opening, a restoring mechanism is provided at the door shaft; the labyrinth sealing structure of the door body and that of the door frame are cooperated with each other for labyrinth sealing so as to light seal the housing, when the door body is closed to seal the door opening. Since the door assembly is labyrinth sealed, the requirements for the precision of the parts are decreased and the light tightness becomes more reliable. In addition, since the door assembly is provided on a side wall of the counter, a micro-hole plate is horizontally taken in and out by the operator. Therefore, spilling or leaking of a reagent due to inconvenient operation can be avoided.

### FIELD OF INVENTION

The present invention relates to a door assembly for a semi-automatic micro-hole plate single-photon counter, especially a door assembly provided or mounted on the housing of a semi-automatic micro-hole plate single-photon counter.

### DESCRIPTION OF RELATED ART

At present, the testing process for a semi-automatic micro-hole plate single-photon counter is generally as follows: a sample to be tested and a corresponding reagent are added into the holes of a micro-hole plate and then processed by an operator following a prescribed procedure; a door mounted on the upper wall of the housing of a counter is opened, then the processed micro-hole plate is placed on a horizontal tray inside the housing, and then the door is closed; driven by a driving mechanism, the tray enters into the housing, then a testing starts; after the testing is finished, the door is opened and the micro-hole plate is taken out by an operator.

Very weak fluorescence is tested by said counter and thus the testing results will be affected if only a little light outside the hole to be tested is leaked into the testing portion. Therefore, there are high requirements for light sealing the housing of a counter.

Current semi-automatic micro-hole plate single-photon counters mostly have an upper-opened structure. That is, a door body is provided on the upper wall of the housing of a counter and flexible material is provided between the door body and the housing of the counter for sealing. A special rubber-sealing ring, which is soft, smooth, and leveling is necessary for sealing; otherwise the light tightness will be greatly decreased. Furthermore, the door opening is horizontally disposed as the door is provided on the upper wall of the housing. In such a case a micro-hole plate is vertically operated, i.e. taken out or put inside in a vertical direction. Therefore, the said operation is inconvenient and may easily cause a reagent to be spilled or leaked to contaminate the instruments.

### SUMMARY OF THE INVENTION

The object of the present invention is to provide a door assembly for a semi-automatic micro-hole plate single-photon counter, which can provide more reliable light tightness between the door assembly and the housing of the single-photon counter, decrease requirements for the precision of the parts, and provide more convenient operation.

The present invention provides a door assembly provided on the housing of a semi-automatic micro-hole plate single-photon counter, a door opening being provided in a side wall of the housing, said door assembly being mounted on the door opening and being cooperated with the door opening to open it or close it so as to light seal the housing, said door assembly comprising a door shaft, a door body and a door frame, wherein the door opening is provided in a side wall of the housing; the door frame is fixedly mounted on the door opening; the door body is mounted on the door frame by the door shaft; labyrinth sealing structures which can cooperate with each other are provided on the door body and the door frame; the door body is pivotable around the door shaft so as to open the door body or close the door opening; a restoring mechanism is provided at the door shaft for the door body to automatically return from its opening position to its closing position; the labyrinth sealing structure of the door body and that of the door frame are cooperated with each other for labyrinth sealing so as to light seal the housing, when the door body is closed to seal the door opening.

The restoring mechanism may be a torsion spring provided at the shaft.

The labyrinth sealing structure may be as follows: a plurality of indentations and projections are provided on the side of the door body facing the inside of the housing; other projections and indentations cooperating with those on the door body are provided at corresponding positions on the door frame; the indentations and projections on the door body and those on the door frame are cooperate with each other when the door body is closed for labyrinth sealing.

Since the door assembly is labyrinth sealed, the requirements for the precision of the parts are decreased and the light tightness becomes more reliable. In addition, since the door assembly of the present invention is provided on a side wall of a counter, i.e. the door is side-opened, a micro-hole plate is horizontally taken in and out resulting a convenient operation. Thus spilling or leaking of a reagent due to inconvenient operation can be avoided.

### BRIEF DESCRIPTION OF THE ACCOMPANYING DRAWING

The present invention will be described in detail below in combination with the figures and the embodiments.

FIG. 1 is a schematic view of a semi-automatic micro-hole plate single-photon counter with a door assembly of the present invention provided thereon, wherein the door assembly is in a closed state;

FIG. 2 is a schematic sectional view of an embodiment of the door assembly of the present invention provided on a semi-automatic micro-hole plate single-photon counter, wherein the door body 1 is in an open state and a projected horizontal tray is schematically shown;

FIG. 3 is a schematic sectional view of the door assembly shown in FIG. 2, wherein the door assembly is in a closed state;

FIG. 4 and FIG. 5 are schematic sectional views of a door body and a door frame, respectively;

FIG. 6 is a schematic view similar to FIG. 1, wherein the door assembly is in an open state.

### DETAILED DESCRIPTION OF THE PREFERRED EMBODIMENTS

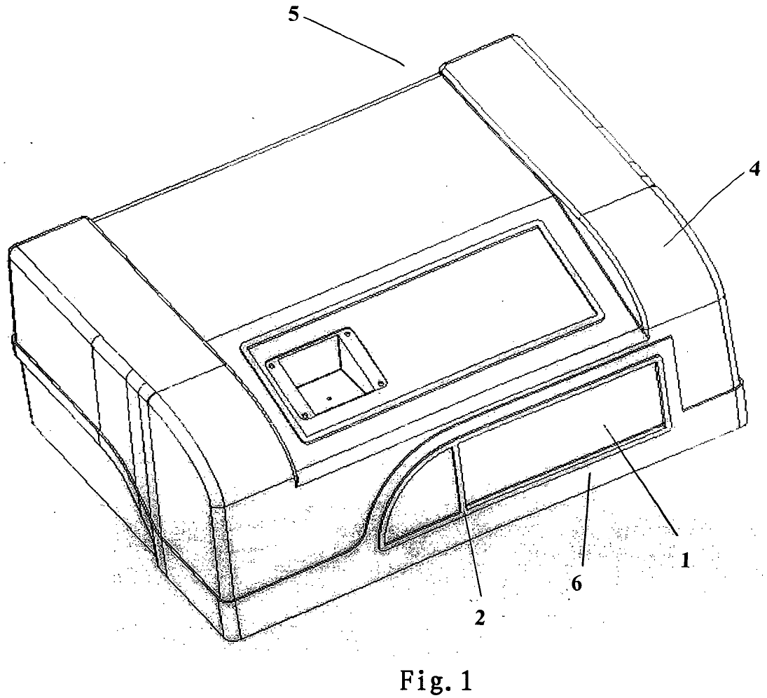

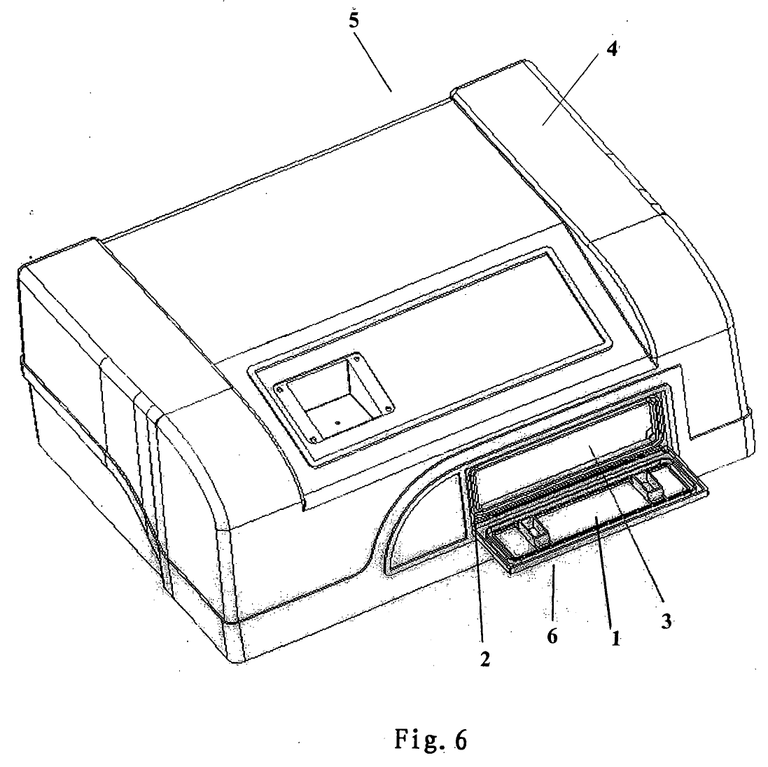

FIGS. 1 and 6 show a door assembly 6 provided on the housing 4 of a semi-automatic micro-hole plate single-photon counter 5 (the door assembly shown in FIG. 1 is in a closed state and that shown in FIG. 6 is in an open state), wherein a door opening 3 is provided in a side wall of the housing 4; a door assembly 6 is mounted on the door opening 3 and can cooperate with the door opening 3 to open or close the door opening 3; the inside of the housing 4 is light sealed when the door opening 3 is closed.

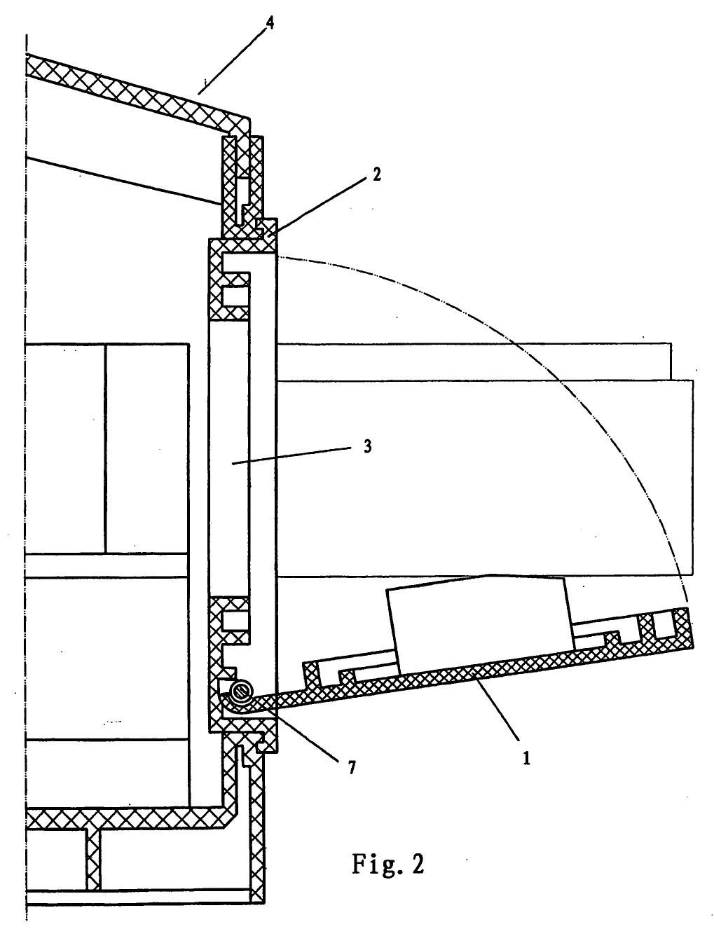

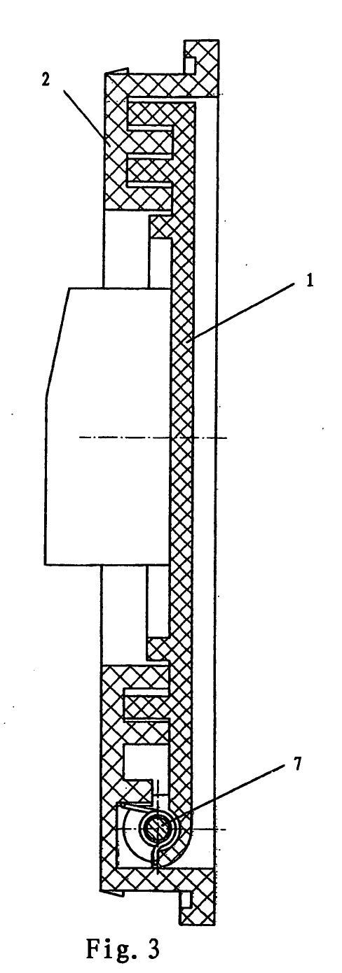

FIG. 2 shows an embodiment of a door assembly of the present invention mounted on the housing 4, wherein the door assembly is in an open state. The door assembly 6 comprises a door shaft 7, a door body 1 and a door frame 2. A door opening 3 is provided in a side wall of the housing 4. The door frame 2 is fixedly mounted on the door opening 3. The door body 1 is mounted on the door frame 2 by a door shaft 7. The door body 1 and the door frame 2 are each provided with a labyrinth sealing structure to cooperate with each other. The door body 1 is pivotable around the door shaft 7 so as to open the door body 1 or close the door opening 3. A restoring mechanism is provided at the door shaft 7 for the door body 1 to automatically restore from its open position to its closed position. The labyrinth sealing structure of the door body 1 and that of the door frame 2 are cooperated with each other for the labyrinth sealing so as to light seal the housing 4, when the door body 1 is closed to seal the door opening 3 as shown in FIG. 3.

The door shaft 7 and the restoring mechanism can be of any type known in the art. For example, the restoring mechanism can be a torsion spring provided at the door shaft 7.

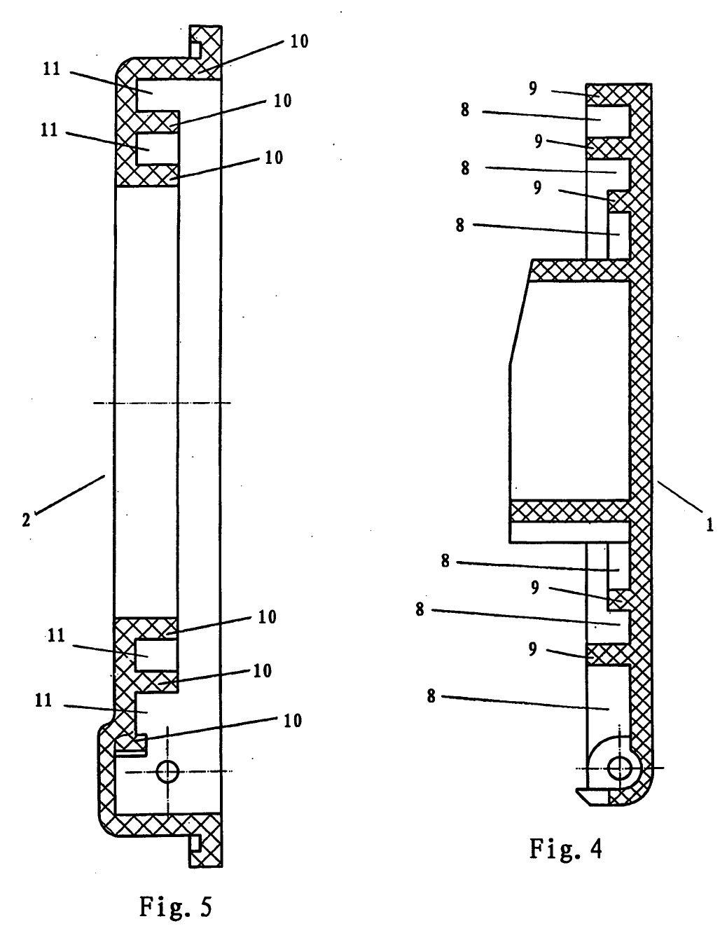

Shown in FIG. 4 and FIG. 5, the labyrinth sealing structure may be as follows: a plurality of indentations 8 and projections 9 are provided on the side of the door body 1 facing the inside of the housing 4; other indentations 10 and projections 11 cooperating with those on the door body 1 are provided at corresponding positions on the door frame 2; the indentations 8 and projections 9 on the door body 1 and the projections 10 and indentations 11 on the door frame 2 are cooperate with each other when the door body 1 is closed for labyrinth sealing.

The number and shape of the indentions and the projections of the door body 1 and the door frame 2 can be arbitrarily selected according to the requirements. For instances, the indentions and the projections can be straight or have a shape of a curved loop, as long as the indentions and the projections of the door body 1 and those on the door frame 2 can be engaged with each other for labyrinth sealing.

With the above-mentioned structure, the indentations and projections provided on the door body 1 and the door frame 2 are engaged with each other for labyrinth sealing, when the door body 1 pivots around the door shaft 7 to close the door opening 3. In this case, the requirements for the precision of the parts are decreased and light tightness becomes more reliable.

In addition, since the door assembly of the present invention is provided on a side wall of the counter, i.e. the door is side-opened, a micro-hole plate is horizontally projected when the door body is opened, as shown in FIGS. 2 and 6. In such a case, a micro-hole plate is horizontally taken in and out by an operator resulting a convenient operation. Therefore spilling or leaking of a reagent due to inconvenient operation can be avoided.

What is claimed is:

1. A door assembly (6) for a semi-automatic micro-hole plate single-photon counter (5), the door assembly being provided on the housing (4) of the semi-automatic micro-hole plate single-photon counter (5), a door opening (3) being provided in a wall of the housing (4), the door assembly (6) being mounted on the door opening (3) and being cooperated with the door opening (3) to open or close it so as to light seal the housing (4), said door assembly comprising a door shaft (7), a door body (1) and a door frame (2), wherein the door opening (3) is provided on a side wall of the housing (4), the door frame (2) is fixedly mounted on the door opening (3), the door body (1) is mounted on the door frame (2) by the door shaft (7), labyrinth sealing structures which can cooperate with each other are provided on the door body (1) and the door frame (2), the door body (1) is pivotable around the door shaft (7) so as to open the door body (1) or close the door opening (3), a restoring mechanism for the door body (1) to automatically return from its opening position to its closing position is provided at the door shaft (7), the labyrinth sealing structure of the door body (1) and that of the door frame (2) are cooperated with each other for labyrinth sealing so as to light seal the housing (4).

2. According to the door assembly of claim 1, wherein said restoring mechanism is a torsion spring (7) provided at the shaft.

3. According to the door assembly of claim 1, wherein the labyrinth sealing structure may be as follows: a plurality of indentations (8) and projections (9) are provided on the side of the door body (1) facing the inside of the housing (4); other projections (10) and indentations (11) cooperating with those on the door body (1) are provided at corresponding positions on the door frame (2); the indentations and projections on the door body (1) and those on the door frame (2) are cooperate with each other when the door body (1) is closed for labyrinth sealing.

4. According to the door assembly of claim 2, wherein the labyrinth sealing structure may be as follows: a plurality of indentations (8) and projections (9) are provided on the side of the door body (1) facing the inside of the housing (4); other projections (10) and indentations (11) cooperating with those on the door body (1) are provided at corresponding positions on the door frame (2); the indentations and projections on the door body (1) and those on the door frame (2) are cooperate with each other when the door body (1) is closed for labyrinth sealing.
